(19) United States
(12) Patent Application Publication
(10) Pub. No.: US 2005/0121138 A1
(43) Pub. Date: Jun. 9, 2005

(54) Preparation of flexible metal foil/polyimide laminate

(75) Inventors: Shigehiro Hoshida, Ibaraki-ken (JP); Toshikatsu Yamamuro, Ibaraki-ken (JP); Tadashi Amano, Ibaraki-ken (JP)

Correspondence Address: BIRCH STEWART KOLASCH & BIRCH, PO BOX 747, FALLS CHURCH, VA, 22040-0747, US

(73) Assignee: Shin-Etsu Chemical Co., Ltd.

(21) Appl. No.: 11/001,017

(22) Filed: Dec. 2, 2004

(30) Foreign Application Priority Data
Dec. 3, 2003 (JP) 2003-404607

(51) Int. Cl. B32B 31/20

(52) U.S. Cl. 156/285; 156/308.2

(57) ABSTRACT

A flexible metal foil/polyimide laminate is prepared by furnishing a composite film including a polyimide film having a Tg≧350° C., sandwiched between polyimide layers having a Tg≦300° C., laying metal foils on opposite sides of the composite film, and continuously hot pressing the resulting stack in a vacuum atmosphere having a vacuum of up to 5 Torr or a nitrogen atmosphere having an oxygen concentration of up to 0.5% by volume. A flexible metal foil/polyimide laminate having improved surface properties can be continuously prepared while preventing the metal foils from being degraded by oxidation.

### CROSS-REFERENCE TO RELATED APPLICATION

This non-provisional application claims priority under 35 U.S.C. §119(a) on Patent Application No. 2003-404607 filed in Japan on Dec. 3, 2003, the entire contents of which are hereby incorporated by reference.

### TECHNICAL FIELD

This invention relates to a method for continuously preparing a flexible metal foil/polyimide laminate which is used as printed circuit boards or flexible printed circuit boards which are useful electronic parts.

### BACKGROUND ART

In the prior art, flexible metal foil/polyimide laminates are prepared by forming a layer of polyimide having a low glass transition temperature, also known as thermoplastic polyimide, on a conductor followed by lamination. See JP-A 1-244841, JP-A 2000-103010, and JP-A 6-190967.

JP-A 1-244841 describes the preparation in a vacuum atmosphere or nitrogen atmosphere. A study on the practical manufacture of metal foil/polyimide laminate reveals the importance of preventing metal foils from oxidation.

However, most prior art methods allow surface metal foils to be degraded by oxidation. It is then difficult to continuously manufacture flexible metal foil/polyimide laminates having improved surface properties while preventing metal foils from being degraded by oxidation.

### SUMMARY OF THE INVENTION

An object of the invention is to provide a method for continuously preparing a flexible metal foil/polyimide laminate having improved surface properties while preventing metal foils from being degraded by oxidation.

According to the invention, there is provided a method for preparing a flexible metal foil/polyimide laminate, comprising the steps of furnishing a composite film including a polyimide film having a glass transition temperature of at least 350° C., sandwiched between polyimide layers having a glass transition temperature of up to 300° C., laying metal foils on opposite sides of the composite film, and continuously hot pressing the resulting structure in a vacuum or nitrogen atmosphere by means of a hot press unit. The vacuum atmosphere should have a vacuum of up to 5 Torr, and the nitrogen atmosphere have an oxygen concentration of up to 0.5% by volume.

The method prevents the metal foils from being degraded by oxidation during the hot pressing step. Thus, a flexible metal foil/polyimide laminate having improved and stable surface properties can be continuously prepared. The resulting flexible metal foil/polyimide laminate is a useful electronic material.

### DESCRIPTION OF THE PREFERRED EMBODIMENTS

The method of the invention starts with a composite film including a polyimide film (A) having a glass transition temperature of at least 350° C., sandwiched between polyimide layers (B) having a glass transition temperature of up to 300° C.

The polyimide film (A) which is a center layer of the composite film should have a glass transition temperature (Tg) of at least 350° C. in order to enhance the heat resistance of the flexible metal foil/polyimide laminate. The Tg of the polyimide film is preferably from 400° C. to 650° C., more preferably from 400° C. to 600° C. A Tg of lower than 350° C. leads to lower heat resistance by which the use or application is restricted.

The polyimide film (A) used herein may be formed by synthesizing a polyamic acid from an acid anhydride and a diamine, followed by imidization.

The acid anhydrides used in the preparation of the polyimide film (A) include tetracarboxylic acid anhydrides and derivatives thereof. It is noted that although examples of tetracarboxylic acid are described below, esters, anhydrides and chlorides of such acids can, of course, be employed. Illustrative examples of suitable tetracarboxylic acid include pyromellitic acid, 3,3′,4,4′-biphenyltetracarboxylic acid, 3,3′,4,4′-benzophenonetetracarboxylic acid, 3,3′,4,4′-diphenylsulfonetetracarboxylic acid, 3,3′,4,4′-diphenylethertetracarboxylic acid, 2,3,3′,4′-benzophenonetetracarboxylic acid, 2,3,6,7-naphthalenetetracarboxylic acid, 1,2,5,6-naphthalenetetracarboxylic acid, 3,3′,4,4′-diphenylmethanetetracarboxylic acid, 2,2-bis(3,4-dicarboxyphenyl)propane, 2,2-bis(3,4-dicarboxyphenyl)hexafluoropropane, 3,4,9,10-tetracarboxyperillene, 2,2-bis[4-(3,4-dicarboxyphenoxy)phenyl]propane, 2,2-bis[4-(3,4-dicarboxyphenoxy)phenyl]hexafluoropropane, butanetetracarboxylic acid, and cyclopentanetetracarboxylic acid. Also included are trimellitic acid and derivatives thereof.

It is also possible to introduce a crosslinked structure or ladder structure through modification with a compound having a reactive functional group.

Examples of the diamine used in the preparation of the polyimide film (A) include p-phenylenediamine, m-phenylenediamine, 2′-methoxy-4,4′-diaminobenzanilide, 4,4′-diaminodiphenyl ether, diaminotoluene, 4,4′-diaminodiphenylmethane, 3,3′-dimethyl-4,4′-diaminodiphenylmethane, 3,3′-diethyl-4,4′-diaminodiphenylmethane, 2,2-bis[4-(4-aminophenoxy)phenyl]propane, 1,2-bis(anilino)ethane, diaminodiphenyl sulfone, diaminobenzanilide, diaminobenzoate, diaminodiphenyl sulfide, 2,2-bis(p-aminophenyl)propane, 2,2-bis(p-aminophenyl)hexafluoropropane, 1,5-diaminonaphthalene, diaminotoluene, diaminobenzotrifluoride, 1,4-bis(p-aminophenoxy)benzene, 4,4′-(p-aminophenoxy)biphenyl, diaminoanthraquinone, 4,4′-bis(3-aminophenoxyphenyl)diphenyl sulfone, 1,3-bis(anilino)hexafluoropropane, 1,4-bis(anilino)octafluoropropane, 1,5-bis(anilino)decafluoropropane, 1,7-bis(anilino)tetradecafluoropropane, 2,2-bis[4-(p-aminophenoxy)phenyl]hexafluoropropane, 2,2-bis[4-(3-aminophenoxy)phenyl]hexafluoropropane, 2,2-bis[4-(2-aminophenoxy)phenyl]hexafluoropropane, 2,2-bis[4-(4-aimonophenoxy)-3,5-dimethylphenyl]-hexafluoropropane, 2,2-bis[4-(4-aimonophenoxy)-3,5-ditrifluoromethylphenyl]-hexafluoropropane, p-bis(4-amino-2-trifluoromethylphenoxy)benzene, 4,4′-bis(4-amino-2-trifluoromethylphenoxy)biphenyl, 4,4′-bis(4-amino-3-trifluoromethylphenoxy)biphenyl, 4,4′-bis(4-amino-2-trifluoromethylphenoxy)diphenyl sulfone, 4,4′-bis(4-amino-5-trifluoromethylphenoxy)diphenyl sulfone, 2,2-bis[4-(4-amino-3-trifluoromethylphenoxy)phenyl]-hexafluoropropane, benzidine, 3,3′,5,5′-tetramethylbenzidine, octafluorobenzidine, 3,3′-methoxybenzidine, o-tolidine, m-tolidine, 2,2′,5,5′,6,6′-hexafluorotolidine, 4,4″-diaminoterphenyl, and 4,4′″-diaminoquarterphenyl. Also included are diisocyanates obtained through reaction of the foregoing diamines with phosgene or the like, and diaminosiloxanes.

Any of the existing methods may be used to prepare polyimide films. The preparation method is not particularly limited. Commercial products of polyimide film may also be used as listed below.
Apical (trade name) by Kaneka Corp.
Kapton (trade name) by Dupont
Upilex (trade name) by Ube Industries, Ltd.

The thickness of the polyimide film (A) is preferably in the range of 5 μm to 50 μm, more preferably 5 μm to 25 μm for ease of film handling. A film with a thickness of less than 5 μm is limp and awkward to handle and tends to wrinkle whereas a film in excess of 50 μm is uneconomical.

The polyimide layers (B) laminated to opposite surfaces of the polyimide film (A) should have a Tg of up to 300° C. From the standpoint of soldering heat resistance, the Tg of the polyimide layer is preferably from 150° C. to 300° C., more preferably from 200° C. to 300° C. With a Tg in excess of 300° C., heating to a very high temperature is necessary to achieve lamination, which in turn, necessitates an expensive equipment.

The polyimide layer (B) need not be thick because it helps lamination of a metal foil. The thickness of the polyimide layer (B) is preferably up to 5 μm, more preferably from 2 μm to 5 μm. A thickness of more than 5 μm is uneconomical.

In the invention, a composite film is formed by combining two types of polyimide. It is not critical how to combine two types of polyimide. For example, the polyimide (A) to serve as the center layer is formed into a film, on which the polyimide (B) to serve as the outer layers is coated or laid. Alternatively, the polyimide (A) to serve as the center layer and the polyimide (B) to serve as the outer layers are co-formed into a film. As used herein, formation of polyimide into a film may be effected by any polyimide film-producing methods, with casting or extrusion being often utilized.

The metal foil used herein may be of copper, iron, molybdenum, zinc, tungsten, nickel, chromium, aluminum, silver or alloys thereof, such as stainless steel. Copper is the preferred electronic material most commonly used in printed circuit boards and flexible boards.

The metal foil serving as conductor may be surface treated as by metal plating, surface oxidation or texturing. Treatment with coupling agents, typically silane coupling agents is also acceptable. The thickness of the metal foil is preferably from 5 μm to 50 μm, more preferably from 5 μm to 25 μm.

According to the invention, the metal foils are laid on opposite sides of the composite polyimide film to provide a stack, which is then hot pressed. The hot pressing method may be selected from well-known methods, for example, the roll lamination method of feeding a stack between a pair of metal rolls for lamination as described in JP-A 8-244168, JP-A 2003-118060 and JP-A 5-31869, and the double belt press method as described in JP-A 9-116254.

The heating temperature used in the hot pressing should be equal to or greater than the Tg of the outside polyimide (B) and preferably equal to or greater than 280° C., more preferably equal to or greater than 330° C. It is also preferred that the heating temperature be equal to or lower than the Tg of the center polyimide (A). The pressure used in the hot pressing varies with the flow of polyimides used. Specifically, when a roll laminator is employed, the pressure is preferably a linear pressure of at least 5 kg/cm, more preferably at least 10 kg/cm; and when a belt press machine is employed, the pressure is preferably a surface pressure of at least 10 kg/cm², more preferably at least 20 kg/cm². The upper limit of pressure may be suitably selected, and a higher pressure can be applied as long as it does not cause damage or failure.

To prevent the metal foil from oxidation, the foil/film/foil stack must be continuously hot pressed in a vacuum or nitrogen atmosphere by means of a hot press unit. The vacuum atmosphere should have a vacuum of up to 5 Torr, preferably up to 4 Torr, more preferably up to 3 Torr. A vacuum of more than 5 Torr may allow for oxidation of the metal foil. The nitrogen atmosphere should have an oxygen concentration of up to 0.5% by volume, preferably up to 0.4% by volume, more preferably up to 0.3% by volume. An oxygen concentration of more than 0.5% by volume may allow for oxidation of the metal foil as well.

When the vacuum or nitrogen atmosphere is established, it is preferred that an overall hot press system including feed rolls and a take-up roll be coupled with a vacuum unit or disposed in a nitrogen atmosphere for enabling continuous hot pressing because the overall system becomes simple. The invention is not limited to these settings. In an alternative embodiment, a hot pressing or laminating unit is disposed apart from feed rolls and a take-up roll, a vacuum or nitrogen atmosphere is established only in the laminating unit, and a seal is provided between the feed or take-up roll and the laminating unit for maintaining the vacuum or nitrogen atmosphere in the laminating unit.

In a preferred embodiment of the invention, the hot press unit includes portions that come in contact with the metal foils, which portions are made of hard alloy. The portions of the hot press unit in contact with the metal foils are typically pressing rolls. As a general rule, hot pressing or lamination is possible with rolls of stainless steel or chrome-plated carbon steel, but these rolls are likely to give rise to a phenomenon that metal foils are broken during the lamination although the reason is not well understood. The use of hard alloy eliminates or suppresses such a phenomenon. As used herein, the hard alloy refers to not only tungsten carbide bonded with cobalt, nickel or the like as commonly used, but also hard metals based on high hardness (Vickers hardness 1,000 or higher) compounds such as aluminum oxide, chromium carbide, silicon carbide and boron carbide. Of these, use of tungsten carbide and chromium carbide is preferred. The hard alloy should preferably have a Vickers hardness of at least 1,000 and up to 3,000.

Since the laminating unit is disposed in a vacuum or nitrogen atmosphere as described above, the hard alloy used in the press portions in contact with the metal foils is not oxidized, which suggests possible degradation of the hard alloy surface. To prevent such undesirable degradation, the surface of hard alloy is oxidized at intervals. An oxidized, protective film is then formed on the hard alloy surface for thereby preventing surface degradation over a long term.

### EXAMPLE

Examples of the invention are given below by way of illustration and not by way of limitation. It is noted that the glass transition temperature Tg (° C.) is measured by the differential scanning calorimetry (DSC).

### Example 1

Thermoplastic polyimide layers (Tg 242° C.) of about 3 μm thick were laminated on opposite sides of a center polyimide film (Tg higher than 400° C., 25 μm thick, Upilex VT from Ube Industries, Ltd.) to form a composite film. Copper foils (rolled copper foils, 18 μm thick, Japan Energy Co., Ltd.) were laid on opposite sides of the composite film. Using a roll laminator (Nishimura Machinery Co., Ltd.), the resulting stack was hot pressed at a temperature of 300° C. and a pressure of 20 kg/cm and the bonded laminate was taken up in roll form. The roll laminator included a pair of pressing rolls surface lined with tungsten carbide-base alloy. For lamination, the hot pressing unit was placed in a vacuum vessel having a vacuum of 3 Torr.

The press bonded laminate was evaluated by a hot tensile test and surface observation. The Tg of center polyimide film was measured. The results are shown in Table 1.

### Comparative Example 1

The procedure of Example 1 was repeated except that the atmosphere during the hot pressing had a vacuum of 7 Torr.

### Example 2

The procedure of Example 1 was repeated except that the vacuum vessel used in Example 1 was purged with nitrogen to atmospheric pressure to establish a nitrogen atmosphere having an oxygen concentration of 0.4% by volume.

### Comparative Example 2

The procedure of Example 2 was repeated except that the nitrogen atmosphere had an oxygen concentration of 0.7% by volume.

### Example 3

220 g of pyromellitic acid (PMDA) was dissolved in 10 kg of dimethylacetamide (DMAc), which was cooled at 10° C. 110 g of p-phenylenediamine (PPD) was slowly added to the solution for reaction, obtaining a polyimide precursor resin solution. The solution was cast, dried and then heated at 350° C. for imidization, forming a polyimide film. This polyimide film had a thickness of 30 μm and a Tg of higher than 400° C.

Thermoplastic polyether imide films (by Mitsubishi Resin Co., Ltd., Tg 216° C., 20 μm thick) were laid on opposite sides of the polyimide film, and copper foils (electrolytic copper foil, Japan Energy Co., Ltd.) were further laid on opposite sides of the film laminate. Using a roll laminator (Nishimura Machinery Co., Ltd.), the resulting stack was hot pressed at 340° C. and 8 kg/cm and the bonded laminate was taken up in roll form. The roll laminator included a pair of pressing rolls surface lined with chromium carbide-base alloy. For lamination, the hot press unit was placed in a nitrogen atmosphere having an oxygen concentration of 0.2% by volume.

The press bonded laminate was evaluated by a hot tensile test and surface observation. The Tg of center polyimide film was measured. The results are shown in Table 1.

### Example 4

The procedure of Example 3 was repeated except that the hot pressing was carried out at 280° C. and 50 kg/cm.

### Example 5

The procedure of Example 3 was repeated except that the center polyimide film used was Upilex S (Tg>400° C., 25 μm thick) from Ube Industries, Ltd.

### Example 6

The procedure of Example 5 was repeated except that the hot pressing rolls were chrome-plated on their surface.

### Comparative Example 3

The procedure of Example 3 was repeated except that the center polyimide film used was a polyether imide film (Tg 216° C., 20 μm thick) from Mitsubishi Resin Co., Ltd.

### Comparative Example 4

The procedure of Example 5 was repeated except that the outside polyimide films used were polyimide films Kapton EN (Tg 355° C., 25 μm thick) from Dupont.

It is noted that the hot tensile test and surface observation were carried out as follows.

Hot tensile test

According to JIS C2318, the tensile strength of a test strip of 1 cm wide was measured in a thermostat oven at 200° C. by a tensile tester model UCT by Orientec Co., Ltd.

Surface Observation

The surface of the laminate was visually observed to examine whether or not the surface was discolored and whether or not the copper foil was peeled off.

TABLE 1

| | | | | | Compar- | | | | | | |
|---|---|---|---|---|---|---|---|---|---|---|---|
| | | | Compar- | | ative | | | | | Compar- | Compar- |
| | | Exam- | ative | Exam- | Exam- | Exam- | Exam- | | Exam- | ative | ative |
| Example | | ple 1 | Example 1 | ple 2 | ple 2 | ple 3 | ple 4 | Example 5 | ple 6 | Example 3 | Example 4 |
| Heating temperature | | 300 | 300 | 300 | 300 | 340 | 280 | 340 | 340 | 340 | 340 |
| (° C.) | | | | | | | | | | | |
| Bonding pressure | | 20 | 20 | 20 | 20 | 8 | 50 | 8 | 8 | 8 | 8 |
| (kg/cm) | | | | | | | | | | | |
| Vacuum (Torr) or | | 3 | 7 | 0.4 | 0.7 | 0.2 | 0.2 | 0.2 | 0.2 | 0.2 | 0.2 |
| O₂ concentration | | Torr | Torr | vol % | vol % | vol % | vol % | vol % | vol % | vol % | vol % |
| (vol %) | | | | | | | | | | | |
| Roll material | | WC | WC | WC | WC | CrC | CrC | CrC | Cr- | CrC | CrC |
| (Vickers hardness) | | (1000- | (1000- | (1000- | (1000- | (1000- | (1000- | (1000- | plating | (1000- | (1000- |
| | | 1500) | 1500) | 1500) | 1500) | 1500) | 1500) | 1500) | (200- | 1500) | 1500) |
| | | | | | | | | | 400) | | |
| Hot tensile test | | 22 | 22 | 22 | 22 | 28 | 28 | 24 | 24 | 3 | * |
| (kg/mm²) | | | | | | | | | | | |
| Surface | Discoloration | ◯ | X | ◯ | X | ◯ | ◯ | ◯ | ◯ | ◯ | * |
| observation | Foil | ◯ | ◯ | ◯ | ◯ | ◯ | ◯ | ◯ | Δ | ◯ | * |
| | peeling | | | | | | | | | | |

| | | | | | | | | | | |
|---|---|---|---|---|---|---|---|---|---|---|
| Center polyimide Tg | 540 | 540 | 540 | 540 | 490 | 490 | 550 | 550 | 216 | 550 |
| (° C.) | | | | | | | | | | |
| Outside polyimide Tg | 242 | 242 | 242 | 242 | 216 | 216 | 216 | 216 | 216 | 355 |
| (° C.) | | | | | | | | | | |

*In Comparative Example 4, copper foils peeled off immediately after press bonding, that is, could not be bonded in a substantial sense.
Surface discoloration
◯: not discolored
X: copper foil discolored by oxidation
Copper foil peel
◯: no peel
Δ: copper foil partially peeled
X: copper foil substantially peeled

Japanese Patent Application No. 2003-404607 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A method for preparing a flexible metal foil/polyimide laminate, comprising the steps of:
furnishing a composite film including a polyimide film having a glass transition temperature of at least 350° C., sandwiched between polyimide layers having a glass transition temperature of up to 300° C.,
laying metal foils on opposite sides of the composite film, and
continuously hot pressing the resulting stack in a vacuum atmosphere having a vacuum of up to 5 Torr or a nitrogen atmosphere having an oxygen concentration of up to 0.5% by volume, by means of a hot press unit.

2. The method of claim 1, wherein the vacuum atmosphere has a vacuum of up to 4 Torr.

3. The method of claim 1, wherein the nitrogen atmosphere has an oxygen concentration of up to 0.4% by volume.

4. The method of claim 1, wherein said hot press unit includes portions in contact with the metal foils, the portions being made of hard alloy.

5. The method of claim 4, wherein the portions of hard alloy are oxidized on their surface prior to use.
